(19) United States
(12) Patent Application Publication
(10) Pub. No.: US 2021/0053583 A1
(43) Pub. Date: Feb. 25, 2021

(54) Consideration of Driving Time Periods for Automated Driving in a Digital Appointment Calendar

(71) Applicant: Bayerische Motoren Werke Aktiengesellschaft, Muenchen (DE)

(72) Inventor: Michael SCHRAUT, Muenchen (DE)

(21) Appl. No.: 16/964,699

(22) PCT Filed: Jan. 31, 2019
(86) PCT No.: PCT/DE2019/100100

§ 371 Date: Jul. 24, 2020

(30) Foreign Application Priority Data
Feb. 15, 2018 (DE) 10 2018 202 334.4

(51) Int. Cl. B60W 50/08; G06Q 10/10; G01C 21/36

(52) U.S. Cl. CPC B60W 50/082; G06Q 10/1093; B60W 2556/45; G01C 21/3697; B60W 50/085

(57) ABSTRACT

A method expands a first digital appointment calendar having appointments to include driving time periods for automated driving. A driving demand for a person is determined. The person is, for example, the person who maintains the first digital appointment calendar as a personal appointment calendar. The driving demand can be determined, for example, by analyzing data of the first appointment calendar in such a way that, for each of one or more individual appointments, a journey demand corresponding to the driving demand, for the journey to the appointment in question, is determined. On the basis of the determined driving demand, a trip of said person with a motor vehicle designed for automated driving is planned. One or more trip segments for automated driving on the planned trip are determined. On the basis of the one or more determined trip segments for automated driving, one or more driving time periods for automated driving are determined. The one or more driving time periods for automated driving thus determined are considered in the first digital appointment calendar. The driving time periods for automated driving are preferably embedded in the time schedule of the digital appointment calendar.

### BACKGROUND AND SUMMARY OF THE INVENTION

The invention relates both to automated driving and to digital appointment calendars.

Digital appointment calendars for storing appointments can be stored locally on a user's terminal, e.g. on a personal computer or smartphone. A digital calendar can also be made available by a data server, e.g. by a Microsoft Exchange Server which can be accessed by client devices, e.g. a personal computer via Microsoft Outlook, or a smartphone.

The term “automated driving” can be understood within the scope of this document to mean driving with automated longitudinal or transverse guidance or autonomous driving with automated longitudinal and transverse guidance. Automated driving preferably comprises driving over a relatively long time, e.g. on a freeway (also referred to as driving with a freeway pilot). The term “automated driving” comprises automated driving with any desired degree of automation. Exemplary degrees of automation are assisted, partially automated, highly automated or fully automated driving. These degrees of automation have been defined by the Federal Highway Research Institute (Bundesanstalt für Straβenwesen (BASt)), (see BASt publication “Forschung kompakt [Research in brief]”, issue 11/2012). During assisted driving, the driver continuously carries out the longitudinal or transverse guidance while the system assumes the respective other function within certain limits. During partially automated driving (TAF), the system assumes the longitudinal and transverse guidance for a certain time period and/or in specific situations, wherein the driver must continuously monitor the system as in the case of assisted driving. During highly automated driving (HAF), the system assumes the longitudinal and transverse guidance for a certain time period without the driver having to continuously monitor the system; however, the driver must be able, within certain limits, to assume the guidance of the vehicle. During fully automated driving (VAF), the system can automatically control the driving in all situations for a specific application situation; for this application situation a driver is no longer necessary. The four degrees of automation which are specified above correspond to the SAE levels 1 to 4 of Standard SAE J3016 (SAE—Society of Automotive Engineering). For example, highly automated driving (HAF) corresponds to level 3 of Standard SAE J3016. In addition, in SAE J3016, the SAE level 5 is provided as highest degree of automation, which is not included in the definition of the BASt. The SAE level 5 corresponds to driverless driving, during which the system can automatically cope with all situations in the same manner as as a human driver during the entire journey; a driver is generally no longer necessary.

In the case of driving with a degree of automation SAE level 3 or higher, the driver no longer has to continuously monitor the driving system and can therefore dedicate himself/herself to other activities than driving. In this context, activities in which the driver is required to look away from the roadway are even possible. These activities can be professional activities or serve private purposes, for example reading, processing or producing documents or messages, e.g. emails, making video calls, watching a video or surfing the Internet. Secondary activities during which the driver is not required to look away from the roadway, e.g. making audio calls or listening to an audio book, can frequently be carried out more easily during automated driving.

A driving function for automated driving, for example for partially automated or highly automated driving, can, with the exception of SAE level 5, normally not be used during the entire drive, but rather is tied to the presence of specific parameters, for example to the type of road (for example highly automated driving is possible only on certain types of road such as a freeway) or to the release of a section of road for the driving function.

Document EP 3 115 942 A1 discloses a method for planning activities for a driver of an automated vehicle, during which activities parts of a planned route are assigned to an automated driving mode, and secondary activities for these parts of the route are proposed to the driver.

US 2016/0229414 A1 discloses determining route sections for automated driving on a route, determining the times of the sections and determining the overall time for automated driving on the route, and outputting this overall time to the driver.

In WO 2016/207140 A1 a time schedule of a journey of a motor vehicle is determined in accordance with an adjustable driving mode (e.g. highly automated driving or manual driving), and the schedule of the journey is displayed.

An object of the invention is to disclose methods and devices for appropriately using driving sections of a driving route in which automated driving is possible for other activities than driving.

The object is achieved by means of the features of the independent patent claims. Advantageous embodiments are described in the dependent claims. It is noted that additional features of a patent claim which is dependent on an independent patent claim can form, without the features of the independent patent claim or only in combination with a subset of the features of the independent patent claim, a separate invention which is independent of the combination of all the features of the independent patent claim and which can be made the subject matter of an independent claim, of a divisional application or of a subsequent application. This applies in the same way to technical teachings which are described in the description and which can form an invention which is independent of the features of the independent patent claims.

A first aspect of the invention relates to a method for expanding a first digital appointment calendar, comprising appointments, with driving time periods for automated driving.

According to the method, a (preferably future) driving requirement is determined for a person. This is, for example, the person who is keeping the first digital appointment calendar as a personal appointment calendar. The driving requirement can be determined, for example, by data of the first (or of a second) appointment calendar being analyzed in such a way that for one or more individual appointments a journey requirement corresponding to the driving requirement for the journey to the respective appointment is respectively determined.

The driving requirement could be a current driving requirement, since the person has to directly change location. However, it is preferably a future driving requirement which is determined.

On the basis of the determined driving requirement it is possible to plan driving by this person with a motor vehicle (in particular passenger car) which is configured for automatic driving. This journey planning is preferably carried out before the person enters his/her motor vehicle and is preferably carried out by a vehicle-external device for route planning. The route to a destination can be determined, for example, on a vehicle-external server.

One or more driving sections for automated driving on the planned drive are determined. These driving sections for automated driving have, for example, the property that automated driving should be available at least essentially for the entirety of the respective driving section.

One or more driving time periods for automated driving are determined on the basis of the one or more determined driving sections for automated driving. For this purpose, route-related information of a driving section is converted into time-related information, for example. A driving time period comprises time information relating to the respective driving section and supplies information about the duration of the section (for example start time and end time or start time and duration).

It is conceivable, but not absolutely necessary, that the driving time period can be used in its entirety for automated driving (e.g. for highly automated driving); for example the driving time period can also comprise one or more short areas for which it is already known at the time of the planning of the driving that the automatic driving mode is not possible. These areas can therefore be, as it were, filtered away.

The one or more driving time periods which are determined in this way for automated driving are therefore taken into account in the first digital appointment calendar. The driving time periods for automated driving are preferably embedded in the time sequence of the digital appointment calendar, for example as new appointments and/or as highlighted time periods, which can in turn be assigned to appointments, e.g. for a meeting via telecommunication means. The time periods can be embedded here in the database, stored in an appointment calendar memory, of the first digital appointment calendar and/or in the display of the digital appointment calendar.

However, the driving time periods can, for example, also be considered in such a way that when a new appointment is entered into the first digital calendar, in particular for a meeting via telecommunication means, such a driving time period is automatically proposed as a suitable time period by the system as a suitable time period for the new appointment.

As a result of the fact that the driving time period or periods are considered in the first digital appointment calendar, in particular are embedded in the time sequence of the appointment calendar, the driving time period or periods can be used to plan an activity during the respective time period. For example, meeting appointments via telecommunication means, e.g. video calls or audio calls or professional functions, e.g. processing of a document, can be assigned to driving time periods which are embedded in the calendar.

The first digital calendar is preferably the personal calendar of that person to whom the (preferably future) driving requirement is assigned. However, it would also be conceivable that the first digital calendar is the digital calendar of another person who is, for example, looking for a suitable appointment for a telephone discussion with the person to whom the driving requirement relates, and can then use this time period of automated driving for the discussion with this person.

It can also be a communal appointment calendar for a group of persons, wherein the group of persons then comprises at least the person for whom the driving requirement is determined.

It is advantageous if the driving requirement is determined by analyzing data of the first appointment calendar (or data of another, second appointment calendar). In this context, a journey requirement (corresponding to the driving requirement) for the journey to the respective appointment is then respectively determined for one or more individual appointments which are stored in the analyzed appointment calendar. For example, the location at which the appointment takes place is read out of the respective appointment. Alternatively, the location of the appointment can also be determined by virtue of the fact that the workplace or residential address of a party to the appointment, who is specified in the appointment, is read out of a digital address book. The location of the appointment can also be determined from the history, for example in the case of recurring appointments. The journey requirement can be derived, for example, by comparing the assumed location of the person before the journey to the appointment and the location of the appointment.

For one or more appointments with a determined journey requirement, a journey to the respective appointment is then planned. On the basis thereof, one or more driving sections are then respectively determined for one or more journeys for automated driving within the scope of the respective journey for the respective appointment. On the basis of the one or more determined driving sections for automated driving for the respective appointment, one or more driving sections are then determined for automated driving for one or more respective appointments. In the first digital appointment calendar, the one or more driving time periods are then considered for automated driving. This can be carried out for a plurality of appointments.

If the first digital appointment calendar whose user is displayed, for example on the screen of a personal computer or on the screen of a smartphone, the driving time periods which are embedded in the appointment calendar, for automated driving, should be highlighted in the displayed first digital appointment calendar, in particular should be easy to differentiate with respect to the appointments. For example, the time periods which are embedded in the appointment calendar for automated driving should be highlighted by means of a uniform color which differs from the color of appointments.

Insofar as a plurality of driving modes for automated driving with different degrees of automation (e.g. HAF and TAF) are to be differentiated, it is possible to use different colors or different variations in the marking method depending on the driving mode, in order to communicate the degree of automation to the user (e.g. blue—HAF, in this case video calls can be made, red—TAF, in this case instead only audio calls can be made). If the motor vehicle supports at least two driving modes for automated driving with different degrees of automation, each driving time period can be assigned a respective driving mode indication which indicates which driving mode is available in the respective driving time period (e.g. driving time period 1: in this case only TAF is available; roadway section 2: in this case HAF is also available). This driving mode indication for a respectively identified driving time period is communicated, for example, by the unit which determines the driving time periods to the unit which integrates the driving time periods into the calendar. When the calendar is being displayed, this driving mode indication can then be read out of the stored calendar, so that the marking method which corresponds to the driving mode (e.g. a blue marking) of the driving time period is displayed in the displayed calendar.

There may be provision that, in addition to driving time periods for automated driving, driving time periods for manual driving are also specified, and when the first digital appointment calendar is displayed a driving time period for manual driving is displayed differently than a driving time period for automated driving (for example the time periods are assigned different colors). The user can then plan, for example, a secondary activity in which his/her eyes do not have to be averted from the the roadway (for example an audio call) in a driving time period with manual driving mode, and a driving time period in which his/her eyes are averted from the roadway (e.g. a video call or reading or processing a document) in a driving time period with highly automated driving.

The use of the driving time periods for automated driving can take place in such a way that the user of the first appointment calendar plans entries (for example meetings or planned activities, e.g. the processing of a document) into the, for example, displayed driving time period in a completely manual fashion. However, this is not absolutely necessary. For example, the appointment calendar can be reorganized and optimized with consideration of the one or more driving time periods in a computer-assisted fashion. A computer (e.g. a server, a personal computer, a smartphone or an on-board computer of a vehicle) analyzes in this case, for example, already existing calendar entries of the first digital appointment calendar in such a way that at least one potential rescheduling of an existing calendar entry to a driving time period for automated driving is identified. In this context, preferably calendar entries are identified which the driver can also carry out in the vehicle during the automated driving mode. Identified possible rescheduling is then proposed to the user of the first digital appointment calendar. This rescheduling can be confirmed by the user, for example, by means of a simple input so that the rescheduling is then carried out. Alternatively, identified possible rescheduling in the first digital appointment calendar could be carried out completely automatically without the user having to confirm this.

A second aspect of the invention relates to a method for considering driving time periods for automated driving in a first digital appointment calendar which comprises appointments.

The method comprises at least the following steps:

receiving one or more driving time periods for automated driving (these driving time periods can result, in particular, from the analysis of the first, or of another, appointment calendar as has been explained above);

considering the one or more driving time periods for automated driving for one or more respective appointments in the first digital appointment calendar, in particular embedding the one or more driving time periods for automated driving for one or more respective appointments in the first digital appointment calendar.

The statements above relating to the method according to the invention according to the first aspect of the invention apply in a corresponding way also to the method according to the invention according to the second aspect of the invention. Advantageous exemplary embodiments of the method according to the invention according to the second aspect of the invention, which are not explicitly described at this point or in the patent claims, correspond to the advantageous exemplary embodiments of the method according to the invention according to the first aspect of the invention which are described above or in the patent claims.

A third aspect relates to a method for making available driving time periods for automated driving so that these can then be considered in a first digital appointment calendar comprising appointments, as has been described above with respect to the first and second aspects of the invention.

The invention comprises the following steps:

detecting a driving requirement for a person;

on the basis of the detected driving requirement, planning driving by this person with a motor vehicle which is configured for automated driving;

determining one or more driving sections for automated driving;

on the basis of the one or more determined driving sections for automated driving, specifying one or more driving time periods for automated driving; and

making available the one or more driving time periods for automated driving in order to consider the driving time periods in the first digital appointment calendar.

The method according to the third aspect of the invention can be configured in such a way that the following steps are carried out:

analyzing data of the first appointment calendar or of a second appointment calendar in such a way that for one or more individual appointments a journey requirement, corresponding to the driving requirement, for the journey to the respective appointment is respectively determined;

for one or more appointments with a determined journey requirement, respectively planning a journey, corresponding to the driving, to the respective appointment, with a motor vehicle which is configured for automated driving;

for one or more journeys, respectively determining one or more driving sections for automated driving on the respective journey for the respective appointment;

on the basis of the one or more determined driving sections for automated driving for the respective appointment, determining one or more driving time periods for automated driving for one or more respective appointments; and

making available the one or more driving time periods for automated driving for one or more respective appointments in order to consider the driving time periods in the first digital appointment calendar. In this context, the one or more driving time periods can be made available with an assignment to the respective appointment.

The above statements relating to the method according to the invention according to the first aspect of the invention apply in a corresponding way also to the method according to the invention according to the third aspect of the invention. Advantageous exemplary embodiments of the method according to the invention according to the third aspect of the invention which are not explicitly described at this point or in the patent claims correspond to the advantageous exemplary embodiments of the method according to the invention according to the first aspect of the invention which are described above or in the patent claims.

A fourth aspect of the invention relates to a device for making available a digital appointment calendar. The device can be implemented on a data server (or on a network of data servers), e.g. as an exchange server which is directly or indirectly coupled to a client device, e.g. a smartphone, a personal computer or a motor vehicle, via a communication link. The device can also be part of a local digital appointment calendar in a user device, e.g. in a smartphone, in a personal computer or in a motor vehicle. The device for making available a digital appointment calendar comprises an appointment calendar memory with a stored first digital appointment calendar which comprises appointments. The appointment calendar memory can be located on a separate server.

In addition, a data input interface for receiving one or more driving time periods for automated driving relating to the driving of a person is provided. The driving time periods have been determined, for example, in a way which has been described above. The data input interface serves preferably for receiving one or more driving time periods for automated driving relating to the journey for one or more respective appointments. In addition, means which are implemented (in particular using software) for considering the one or more driving time periods for automated driving are provided in the first digital appointment calendar which is stored in the appointment calendar memory.

Alternatively there can be provision that via the data input interface it is possible to receive data of an appointment calendar which is expanded with one or more driving time periods for automated driving. In this case, in addition, means (implemented in particular using software) for storing a first appointment calendar, expanded with the one or more driving time periods for automated driving, are provided in the appointment calendar memory.

The above statements relating to the method according to the invention according to the first and second aspects of the invention apply in a corresponding way also to the device according to the invention according to the fourth aspect of the invention. Advantageous exemplary embodiments of the device according to the invention according to the fourth aspect of the invention which are not explicitly described at this point or in the patent claims correspond to the advantageous exemplary embodiments of the method according to the invention according to the first or second aspect of the invention which are described above or in the patent claims.

A fifth aspect of the invention relates to a device for making available driving time periods for automated driving, wherein these driving time periods can be considered in a first digital appointment calendar comprising appointments, by means of the device according to the fourth aspect of the invention. The device comprises an analysis unit for analyzing data of a person, for example from the first, or another, second digital calendar. The analysis unit is configured to determine a driving requirement for this person on the basis of the data of the person, for example as has already been described above. On the basis of the determined driving requirement, driving by this person with a motor vehicle which is configured for automated driving is planned by the analysis unit. For the planned driving, one or more driving sections for automated driving are determined by the analysis unit. On the basis of the one or more determined driving sections for automated driving the analysis unit can specify one or more driving time periods. The analysis unit is configured to make available these one or more driving time periods for automated driving so that they can be considered in the first digital calendar.

As has already been stated above, the analysis unit can serve to analyze data of the first or of a second appointment calendar, wherein the journey requirement is determined on the basis of an appointment entry from the calendar.

The device for making available driving time periods can be integrated into a data server which is separate from a user terminal and the data server for making available the calendar. The device can, however, also be part of a data server for making available the appointment calendar. In addition it is possible that the device for making available driving time periods is also located on a user terminal and corresponds, for example, to an additional software module of software for managing and displaying a digital appointment calendar.

The device for making available driving time periods for automated driving preferably comprises a data input interface for receiving data of the first or second digital appointment calendar which is stored in an appointment calendar memory. In addition, a data output interface for outputting the one or more driving time periods for automated driving for one or more respective appointments, in order to take into account the one or more driving time periods in the first digital appointment calendar, is then preferably provided. Alternatively, data of a first digital appointment calendar which is expanded with the one or more driving time periods for automated driving can also be output.

The above statements relating to the method according to the invention according to the first and third aspects of the invention apply in a corresponding way also to the device according to the invention according to the fifth aspect of the invention. Advantageous exemplary embodiments of the device according to the invention according to the fifth aspect of the invention which are not explicitly described at this point or in the patent claims correspond to the advantageous exemplary embodiments of the method according to the invention according to the first or third aspect of the invention which are described above or in the patent claims.

A sixth aspect of the invention relates to an appointment calendar system with a device for making available a digital appointment calendar according to the fourth aspect of the invention and having a device for making available driving time periods for automated driving according to the fifth aspect of the invention. The two devices can be implemented using software running on a single computer (e.g. a smartphone or a personal computer). The two devices can also be implemented on separate computers, for example on two separate servers. In addition, the system preferably also comprises a device for displaying a digital appointment calendar, for example by means of the monitor of a personal computer, on the display of a smartphone on the screen in the cockpit of the vehicle which is used for automated driving.

A seventh aspect of the invention relates to a computer program product with program code for carrying out a method as described above, according to one of the aspects described above, when the computer program product runs on a computer or on a distributed system of a plurality of computers. The computer may be, for example, a server or a user terminal, for example a personal computer, a smartphone or a motor vehicle.

The invention is described below by means of an exemplary embodiment with reference to the appended drawings.

### BRIEF DESCRIPTION OF THE DRAWINGS

FIG. 1 shows an exemplary appointment calendar system.

FIG. 2 shows an exemplary flowchart relating to the method of functioning of the appointment calendar system.

FIG. 3 shows an exemplary display of a digital appointment calendar before the embedding of the driving time periods for automated driving.

FIG. 4 shows an exemplary display of a digital appointment calendar after the embedding of the driving time periods for automated driving.

FIG. 5 shows an exemplary display of a digital appointment calendar after its optimization with consideration of the driving time periods for automated driving.

### DETAILED DESCRIPTION OF THE DRAWINGS

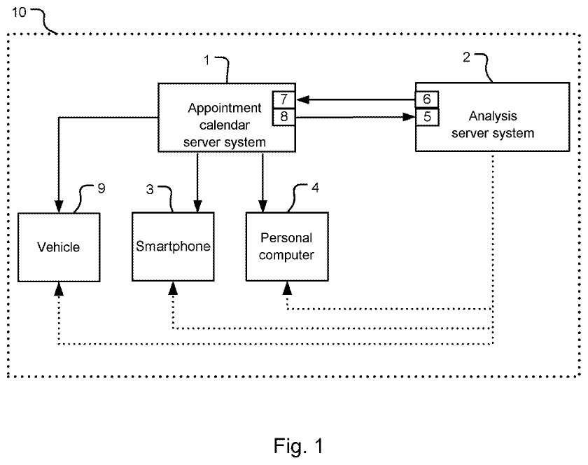

FIG. 1 illustrates an exemplary appointment calendar system 10. The appointment calendar system 10 comprises an appointment calendar server system 1 which comprises one or more data servers. It is, for example, an appointment calendar server system 1 which is based on Microsoft Exchange. A digital personal appointment calendar and, if appropriate, further data (such as for example an email account or an address book) for a multiplicity of persons are stored in the appointment calendar server system 1. Client devices (here a smartphone 3, a personal computer 4, a motor vehicle with a screen for displaying the calendar) of a specific person have access to the digital personal appointment calendar of this person which is stored in the appointment calendar server system. In general a local copy of the appointment calendar which is stored in the appointment calendar server system 1 is held on each of the client devices 3, 4, 9, the devices being regularly synchronized with the appointment calendar which is stored in the appointment calendar server system 1.

In addition, an analysis server system 2 is provided which has access to the digital appointment calendar of this person and comprises one or more data servers. The access to the digital appointment calendar by the analysis server system 2 is carried out, for example, via the appointment calendar server system 1 which is coupled to the analysis server system 2 via a communication link. However, it would also be conceivable for the analysis server system 2 to read out the local digital appointment calendar, stored on the client devices 3, 4 or 9, via a corresponding communication link (not illustrated). For the reading access, the analysis server system has a data input interface 5 for receiving data of the digital appointment calendar which is stored in the appointment calendar server system 1, which data input interface 5 makes available the appointment calendar server system via a data output interface 8. On the basis of the data of the digital appointment calendar, driving time periods for automated driving are determined in the analysis server system 2 and this are transmitted to the appointment calendar server system 1 via a data output interface 6. The appointment calendar server system 1 comprises a data input interface 7 for receiving the driving time periods for automated driving relating to the driving of a person so that the driving time periods can be embedded in the appointment calendar of the person.

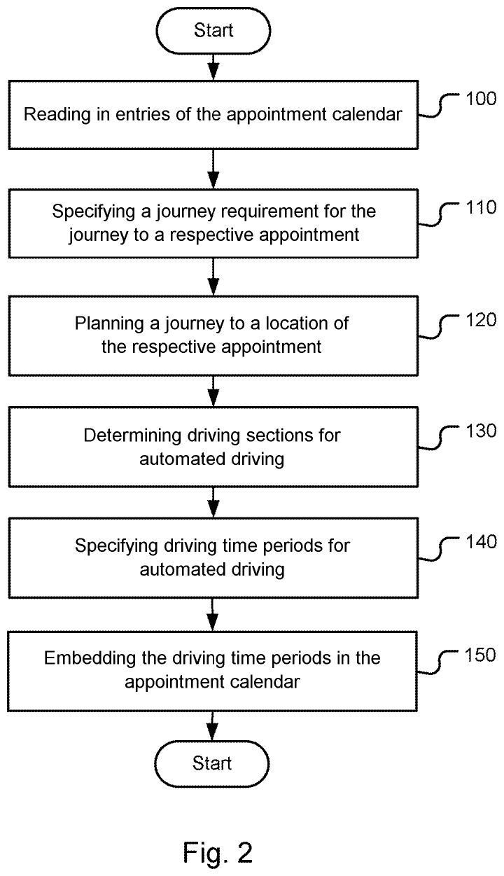

In FIG. 2, the method of functioning of the appointment calendar system 10 is illustrated on the basis of an exemplary flow diagram. In step 100, appointment entries of the digital appointment calendar are read in by the analysis server system 2. In step 110, the entries of the appointment calendar which have been read in are analyzed. In this context it is determined whether, for one or more appointments, there is a respective journey requirement for the respective appointment. For example, the location information for the respective appointment can be used for this.

For appointments with a journey requirement, in step 120 a journey to the location of the respective appointment is respectively planned. For this purpose, the route for the journey is determined by means of a route planner.

In step 130, a route analysis is carried out in which driving sections which are suitable for automated driving are identified on the planned route. For example, in this context driving sections are determined in which highly automated driving is available. Optionally, it is also possible to determine sections which are suitable for partially automated driving (but not for highly automated driving). The driving sections for highly automated driving are in this case handled separately from the driving sections for partially automated driving, in order to be able to display the assigned driving time periods for highly automated driving and the assigned driving time periods for partially automated driving separately in the calendar.

In order to determine the driving sections for automated driving, for example the type of road (e.g. freeway, country road, city traffic) of the individual driving sections of the journey is used as an input variable. Furthermore, variable road conditions (e.g. the expected weather at the time of travel, the time of day which will be applicable then (day, night)) as well as the anticipated traffic situation at the time of the journey (e.g. traffic jam, dense traffic, little traffic) could also be used as input variables.

In step 140, driving time periods for automated driving which are assigned to the driving sections for automated driving are determined for automated driving on a time base. A driving time period has here, for example, a defined start time and a defined end time or a defined start time and an anticipated driving duration for this driving time period. A plurality of driving sections could optionally also be combined to form a driving time period which are interrupted, for example, only by one or more short sections in which automated driving is not available. For an appointment entry, one or more driving time periods can be specified for automated driving for a given degree of automation (e.g. highly automated driving).

After driving time periods for automated driving (e.g. for highly automated driving) have been specified in step 140, this information is transmitted by the analysis server system 2 to the data input interface 7 of the appointment calendar server system 1 via the data output interface 6, wherein the appointment calendar server system 1 embeds the specified individual driving time periods in a correctly timed fashion in the digital appointment calendar before the respective appointment. The client devices 3, 4, 9 then have access to the digital appointment calendar with the embedded driving time periods for automated driving.

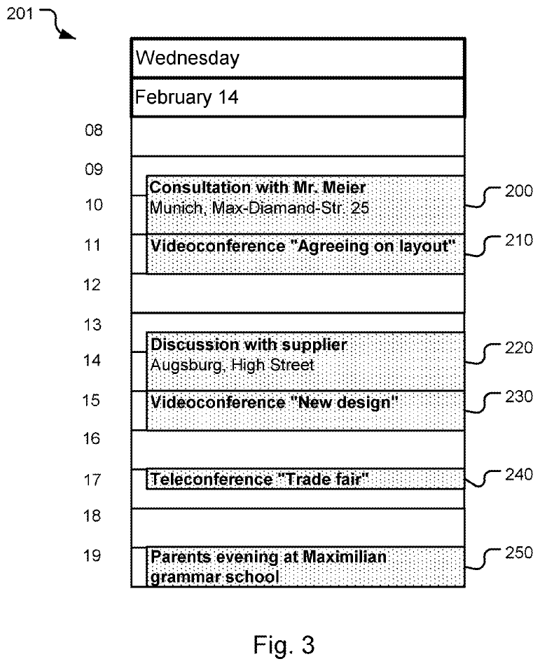

FIG. 3 illustrates an exemplary display of a digital appointment calendar 201 before the embedding of the driving time period for highly automated driving. The digital appointment calendar 201 comprises a multiplicity of appointment entries 200-250. A journey with the motor vehicle is respectively necessary to carry out the appointments 200, 220 and 250.

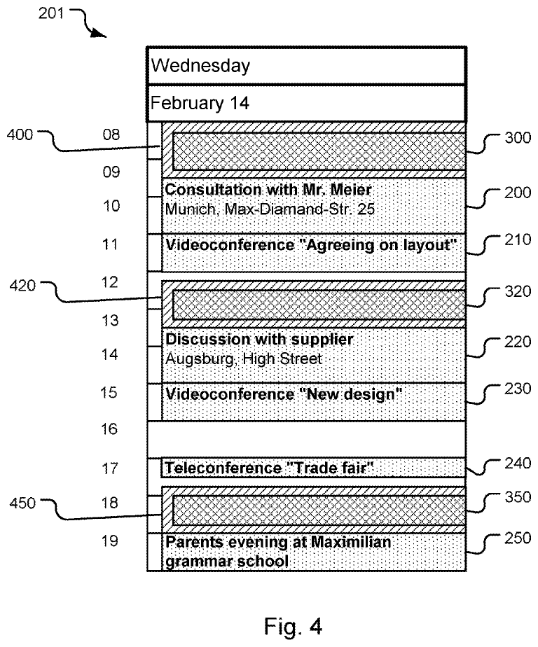

After automated embedding of the driving time periods for highly automated driving, for example the expanded appointment calendar which is illustrated in FIG. 4 is obtained, the appointment calendar being displayed to the user via his/her client device 4, 5, 9. The expanded appointment calendar 201 comprises the embedded driving time periods 300, 320 and 350 for highly automated driving within the respective journey to the respective appointment 200, 220 and 250, which are correspondingly highlighted in the illustration of the appointment calendar 201. In addition, the driving time periods 400, 420, 450 for the respective entire journey are also preferably marked in a correctly timed fashion in the calendar. The driving time periods 300, 320 and 350 for highly automated driving are part of the driving time periods 400, 420, 450 for the respective entire journey. Insofar as the system only supports highly automated driving, the driving driving time periods for the journey correspond, without the respective driving time periods for highly automated driving, to the driving time periods for manual driving. Alternatively or additionally those time periods which correspond to manual driving sections in which the driver has to drive manually can also be explicitly marked in the calendar.

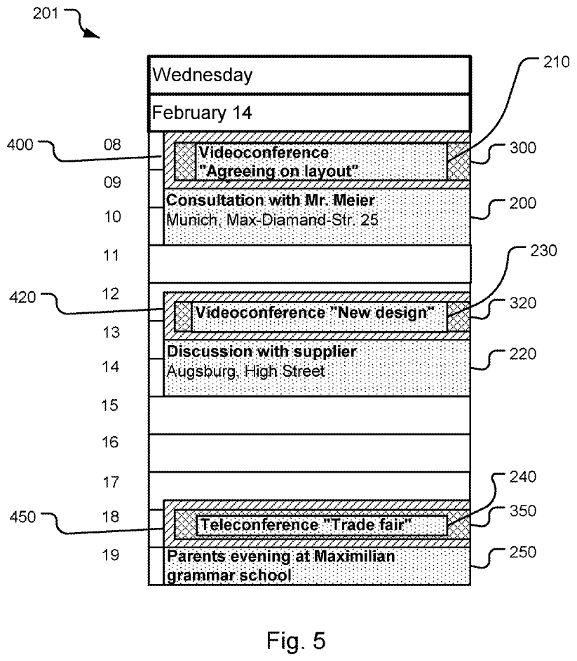

The user of the calendar 201 can then himself/herself optimize the calendar 201 by considering the driving time periods 300, 320 and 350 for highly automated driving. FIG. 5 illustrates the result of the manual optimization of the calendar 201. The appointments 210, 230, 240 for video conferences and telephone conferencing have been rescheduled into the driving time sections 300, 320 and 350 for automated driving.

Instead of rescheduling the appointments manually, it would of course be conceivable for the already existing calendar entries of the digital appointment calendar to be analyzed in such a way that potential rescheduling of at least one appointment of an existing calendar entry to a driving time period for automated driving is identified. In this context, calendar entries are identified which the driver can also carry out in the vehicle during the automated driving mode, e.g. videoconferencing. On the basis thereof the system can then propose identified rescheduling of an appointment to the user (which the user must then only simply accept so that the rescheduling of the appointment is then carried out automatically) or automatically carry out the identified potential rescheduling of the appointment in the digital appointment calendar. It is possible not only to reschedule classic appointments but also other entries in the calendar, for example a planned activity.

In the example in FIG. 3 to FIG. 5, driving time periods for highly automated driving have been identified and integrated into the calendar 201. If the vehicle which is used for the journey supports different driving modes for automated driving with different degrees of automation (e.g. TAF, HAF and VAF), each identified driving time period for automated driving is preferably assigned a driving mode indication which indicates which driving mode is available in the respective driving time period. On the basis of the driving mode indications which can be differentiated for the individual driving modes, a different marking (e.g. different color) is used for the displayed driving time period in the display of the calendar, for example driving time periods marked in blue for HAF (without VAF), driving time periods marked in red for TAF (without HAF and VAF) and time periods marked in green for VAF.

It would, of course, be conceivable to be informed about driving time periods and/or the route sections for automated driving (in particular highly automated driving) within the route lying ahead immediately at the start of a journey in the vehicle (for example by advance evaluation of the route planned in the navigation system). The anticipated availability of a driving mode for automated driving (e.g. highly automated driving) along a displayed driving route can be marked and the length of the route or duration of the availability of the driving mode can be displayed in a corresponding view of the navigation system. Marked route sections for automated driving can be provided with corresponding time indications (e.g. chronological start, chronological end of the route section and/or duration of the route section).

In this context it is also possible to link one or more calendar entries (e.g. 210, 230, 240) to route sections which are marked for automated driving on the route, on the planned route in the view, so that the driver is informed where and/or when on the route a section is available for automated driving and, where appropriate, is used partially or completely for a corresponding appointment entry (e.g. 210, 230 and 240).

1. A method for considering driving time periods for automated driving in a first digital appointment calendar comprising appointments wherein the method comprises the steps:
detecting a driving requirement for a person;
on the basis of the detected driving requirement, planning a journey of this person with a motor vehicle which is configured for automated driving;
determining one or more driving sections for automated driving;
on the basis of the one or more determined driving sections for automated driving, specifying one or more driving time periods for automated driving; and
considering the one or more driving time periods for automated driving in the first digital appointment calendar.

2. The method according to claim 1, wherein the method further comprises the steps:
analyzing data of the first appointment calendar or of a second appointment calendar in such a way that for one or more individual appointments, a journey requirement, corresponding to the driving requirement, for the journey to the respective appointment is respectively determined;
for one or more appointments with a determined journey requirement, respectively planning a journey, corresponding to the driving, to the respective appointment, with a motor vehicle which is configured for automated driving;
for one or more journeys, respectively determining one or more driving sections for automated driving on the respective journey for the respective appointment;
on the basis of the one or more determined driving sections for automated driving for the respective appointment, determining one or more driving time periods for automated driving for one or more respective appointments; and
considering, in the first digital appointment calendar, the one or more driving time periods for automated driving for one or more respective appointments.

3. The method according to claim 1, wherein the step of considering the one or more driving time periods for automated driving in the first digital appointment calendar comprises:
embedding the one or more driving time periods for automated driving in the first digital appointment calendar.

4. The method according to claim 3, comprising the further step:
displaying the first digital appointment calendar wherein driving time periods which are embedded in the appointment calendar, for automated driving in the displayed first digital appointment calendar, are highlighted.

5. The method according to claim 1, comprising the further steps:
analyzing already existing calendar entries of the first digital appointment calendar in such a way that at least one potential rescheduling of an existing calendar entry to a driving time period for automated driving is identified; and
proposing the identified rescheduling to the user of the first digital appointment calendar or automated execution of the identified potential rescheduling in the first digital appointment calendar.

6. The method according to claim 1, wherein
the motor vehicle supports at least two driving modes for automated driving with different degrees of automation, and
a respective driving time period for automated driving is assigned a driving mode indication which indicates which driving mode is available in the respective time period.

7. The method according to claim 6, comprising the further step:
displaying the first digital appointment calendar with marked driving time periods, wherein, depending on the respective assigned driving mode indication, a driving time period for automated driving in a first driving mode of the two driving modes is displayed differently than the driving time period for automated driving in a second driving mode of the two driving modes.

8. The method according to claim 1, wherein
the motor vehicle supports a manual driving mode for manual driving and at least one driving mode for automated driving,
in addition to driving time periods for automated driving, driving time periods for manual driving are also specified, and
when the first digital appointment calendar is displayed, a driving time period for manual driving is displayed differently than a driving time period for automated driving.

9. A method for taking into account driving time periods for automated driving in a first digital appointment calendar comprising appointments, wherein the method comprises the steps:
receiving one or more driving time periods for automated driving; and
taking into account the one or more driving time periods for automated driving in the first digital appointment calendar.

10. A method for making available driving time periods for automated driving for considering these driving time periods in a first digital appointment calendar comprising appointments, wherein the method comprises the steps:
determining a driving requirement for a person;
on the basis of the determined driving requirement, planning a journey of this person with a motor vehicle which is configured for automated driving;
determining one or more driving sections for automated driving;
on the basis of the one or more determined driving sections for automated driving, specifying one or more driving time periods for automated driving; and
making available the one or more driving time periods for automated driving in order to consider the driving time periods in the first digital appointment calendar.

11. The method according to claim 10, wherein the method comprises the steps:
analyzing data of the first appointment calendar or a second appointment calendar in such a way that for one or more individual appointments, a journey requirement, corresponding to the driving requirement, for the journey to the respective appointment is respectively determined;
for one or more appointments with a determined journey requirement, respectively planning a journey, corresponding to the driving, to the respective appointment with a motor vehicle which is configured for automated driving;
for one or more journeys, respectively determining one or more driving sections for automated driving on the respective journey for the respective appointment;
on the basis of the one or more determined driving sections for automated driving for the respective appointment, specifying one or more driving time periods for automated driving for one or more appointments, respectively; and
making available the one or more driving time periods for automated driving for one or more respective appointments, in order to take into account the driving time periods in the first digital appointment calendar.

12. A device for making available a digital appointment calendar, comprising:
a first appointment calendar memory with a stored first digital appointment calendar which comprises appointments,
a data input interface for receiving:
(i) one or more driving time periods for automated driving relating to travel by a person, or
(ii) data of an appointment calendar which is expanded with the one or more driving time periods for automated driving, and
means for considering the one or more driving time periods for automated driving in the first digital appointment calendar stored in the appointment calendar memory, and/or means for storing a first appointment calendar, expanded with the one or more driving time periods, for automated driving, in the appointment calendar memory.

13. A device for making available driving time periods for automated driving, in order to consider these driving time periods in a first digital appointment calendar comprising appointments, which device comprises:
an analysis unit for analyzing data of a person, which is configured to:
determine a driving requirement of the person,
plan, on the basis of the determined driving requirement, travel of this person with a motor vehicle which is configured for automated driving,
determine one or more driving sections for automated driving,
define, on the basis of the one or more determined driving sections for automated driving, one or more driving time periods for automated driving, and
make available these one or more driving time periods for automated driving, in order to take into account the one or more driving time periods in the first digital calendar.

14. The device for making available driving time periods for automated driving according to claim 13, wherein the analysis unit serves to analyze data of the first appointment calendar or of a second appointment calendar, which device, for one or more individual appointments of the first or appointment calendar, is respectively configured to:
determine that there is a journey requirement for the journey to the respective appointment,
plan, on the basis thereof, a journey to the respective appointment with journey demand, with a motor vehicle which is configured for automated driving,
determine one or more journey sections for automated driving of the motor vehicle for the respective appointment,
determine, on the basis of the one or more determined journey sections for automated driving, one or more driving time periods for automated driving and to make available these one or more driving time periods for automated driving, in order to consider the one or more driving time periods in the first digital calendar.

15. The device for making available driving time periods for automated driving according to claim 14, further comprising:
a data input interface for receiving data of the first or second digital appointment calendar which is stored in the appointment calendar memory which comprises appointments; and
a data output interface for outputting
(i) the one or more driving time periods for automated driving for one or more respective appointments, in order to take into account the driving time period or periods in the first digital appointment calendar, or
(ii) data of a first digital appointment calendar which is expanded with the one or more driving time periods for automated driving.

16. An appointment calendar system comprising:
a device for making available a digital appointment calendar comprising:
a first appointment calendar memory with a stored first digital appointment calendar which comprises appointments,
a data input interface for receiving:
(i) one or more driving time periods for automated driving relating to travel by a person, or
(ii) data of an appointment calendar which is expanded with the one or more driving time periods for automated driving, and
means for considering the one or more driving time periods for automated driving in the first digital appointment calendar stored in the appointment calendar memory, and/or means for storing a first appointment calendar, expanded with the one or more driving time periods, for automated driving, in the appointment calendar memory; and
a device for making available driving time periods for automated driving, in order to consider these driving time periods in the first digital appointment calendar comprising appointments, which device comprises:
an analysis unit for analyzing data of a person, which is configured to:
determine a driving requirement of this person,
plan, on the basis of the determined driving requirement, travel of this person with a motor vehicle which is configured for automated driving,
determine one or more driving sections for automated driving,
define, on the basis of the one or more determined driving sections for automated driving, one or more driving time periods for automated driving, and
make available these one or more driving time periods for automated driving, in order to take into account the one or more driving time periods in the first digital calendar.

17. A computer program product comprising a computer readable medium having stored thereon program code for carrying out the method according to claim 1, when the program code runs on a computer or on a distributed system of a plurality of computers.
